(19) United States
(12) Patent Application Publication
(10) Pub. No.: US 2014/0054218 A1
(43) Pub. Date: Feb. 27, 2014

(54) System to Reduce the Fouling of a Catalytic Seawater Deoxygenation Unit

(71) Applicants: Marcus D. Sprenkel, Houston, TX (US); Robert Charles William Weston, Berkshire (GB); Gary Howard Mellor, Berkshire (GB)

(72) Inventors: Marcus D. Sprenkel, Houston, TX (US); Robert Charles William Weston, Berkshire (GB); Gary Howard Mellor, Berkshire (GB)

(21) Appl. No.: 13/591,822

(22) Filed: Aug. 22, 2012

(51) Int. Cl. C02F 1/44; B01D 61/18; C02F 1/68; B01D 65/02; B01D 63/00; B01D 61/08; C02F 103/08

(52) U.S. Cl. 210/636; 210/323.1; 210/198.1; 210/650; 210/639

(57) ABSTRACT

A system and process for reducing fouling in a catalytic bed-based deoxygenation unit include a filtration system having a plurality of selectively permeable membranes arranged to contact a raw seawater feed and provide a membrane permeate. The membrane permeate is comprised of a portion of the raw seawater feed from which contaminants, such as dissolved inorganic salts and organic constituents, have been removed by passing through the selectively permeable membranes. The system and process also include a catalyst bed-based deoxygenation unit that receives the membrane permeate. The filtration system may be a nanofiltration, microfiltration, ultrafiltration, or reverse osmosis membrane system.

### BACKGROUND

This invention relates to systems and processes to reduce the fouling of a catalytic seawater deoxygenation unit. In particular, this invention relates to systems and processes using nanofiltration or reverse osmosis membrane systems in order to remove the dissolved inorganic salts and organic constituents that cause fouling from seawater before deoxygenation occurs. This invention also relates to systems and processes using microfiltration or ultrafiltration in order to remove the organic constituents that cause fouling from seawater before deoxygenation occurs.

Catalyst bed-based seawater deoxygenation units remove dissolved oxygen from seawater by reacting it with hydrogen. This reaction occurs on the open areas of the catalyst bed. However, certain dissolved inorganic salts within seawater can foul the catalyst bed by precipitating from solution and forming deposits on the bed. These deposits, known as scale, reduce the amount of open area on the bed where deoxygenation reactions can occur. Some of the organic constituents in seawater may also collect on the catalyst, further reducing the reactive area of the bed. As a result, the treatment capacity of the deoxygenation unit is decreased, the catalytic deoxygenation system must be taken off-line more frequently for cleaning, and catalyst lifetime is reduced.

Neither multi-media filtration nor cartridge filters are capable of removing all of the constituents that cause fouling from seawater. The typical way to remove fouling is to take the system off-line and wash the catalyst with one or more chemical cleaning agents. Citric acid is typically used for scale, while sodium hypochlorite may be used to control organic constituents. However, using sodium hypochlorite also results in the production of chlorine which, like oxygen, reacts with the hydrogen that is fed into the deoxygenation unit. As a result, more hydrogen and greater catalyst volumes are required to achieve the same level of oxygen removal. Other chemical cleaning agents, such as sodium hydroxide or biocides, may also be used to remove organic constituents from the catalyst. However, using any chemical cleaning agent increases chemical consumption, operational costs, and system downtime. Other issues may arise with chemical handling, storage, and disposal, particularly in off-shore operations. In addition, because the agents cannot always remove all of the scale and organic constituents, the catalyst may not be fully regenerated. The amount of fouling on the catalyst also increases over time. In order to offset the catalyst lost to fouling, catalytic deoxygenation systems may be designed to have more catalyst than necessary for the quantity and quality of water to be treated. Alternatively, the catalyst may be replaced more frequently. Both options result in operational challenges, decreased treatment efficiency, and increased cost.

Thus, a need exists for systems and processes that can remove the major components of inorganic and organic fouling from seawater before it enters a deoxygenation unit. These systems and processes will substantially eliminate scale and organic fouling of the catalyst, resulting in longer run times and more reliable operation for deoxygenation units. Other advantages include increased catalyst lifetime, reduced catalyst volume along with corresponding reductions in treatment vessel size and cost, and reduced consumption of chemical cleaning agents.

### SUMMARY OF THE INVENTION

A system for reducing fouling in a catalytic bed-based deoxygenation unit includes a filtration system having a plurality of selectively permeable membranes arranged to contact a raw seawater feed. The raw seawater feed is passed through the selectively permeable membranes to provide a membrane permeate comprised of a portion of the seawater feed from which contaminants, such as dissolved inorganic salts and organic constituents, have been removed. The system also includes a catalyst bed-based deoxygenation unit that receives the membrane permeate. The filtration system may be a nanofiltration, microfiltration, ultrafiltration, or reverse osmosis membrane system. The filtration system may have one or two stages.

A process for reducing fouling in a catalytic bed-based deoxygenation unit includes the steps of providing a filtration system having a plurality of selectively permeable membranes arranged to contact a raw seawater feed, passing a portion of the raw seawater feed through the selectively permeable membranes to produce a membrane permeate from which contaminants have been removed, and routing the membrane permeate to a catalyst bed-based deoxygenation unit. The filtration system may be a nanofiltration, microfiltration, ultrafiltration, or reverse osmosis membrane system, and the contaminants may be dissolved inorganic salts and/or organic constituents. The filtration system may have one or two stages.

### BRIEF DESCRIPTION OF THE DRAWINGS

FIG. 1 shows a preferred embodiment of the system for reducing fouling in a catalytic bed-based deoxygenation unit according to this invention. The filtration system in FIG. 1 is a two-stage nanofiltration membrane system.

FIG. 2 shows a preferred embodiment of the system for reducing fouling in a catalytic bed-based deoxygenation unit according to this invention. The filtration system in FIG. 2 is a single stage reverse osmosis membrane system.

FIG. 3 shows a preferred embodiment of the system for reducing organic fouling of a catalytic bed-based deoxygenation unit according to this invention. The filtration system in FIG. 3 is a single stage microfiltration or ultrafiltration membrane system.

### ELEMENTS AND ELEMENT NUMBERING USED IN THE DRAWINGS AND THE DETAILED DESCRIPTION

10 Filtration system

20 Two-stage nanofiltration membrane system

30 Catalyst bed-based deoxygenation unit

40 Raw seawater feed

50 First stage nanofiltration membrane unit

60 First stage nanofiltration membrane unit

70 Membrane permeate

80 Membrane reject

90 Membrane permeate

95 Combined membrane permeate stream from first stage

98 Combined membrane permeate stream from first and second stages

100 Membrane reject

105 Combined membrane reject stream

110 Second stage nanofiltration membrane unit

120 Membrane permeate

130 Concentrated membrane reject

140 Hydrogen supply

150 Combined membrane permeate and hydrogen stream

160 Deoxygenated seawater product

165 Filtration system

170 Single-stage reverse osmosis membrane system

180 Reverse osmosis membrane unit

190 Reverse osmosis membrane unit

200 Membrane permeate

210 Membrane reject

220 Membrane permeate

225 Combined membrane permeate stream

230 Membrane reject

240 Concentrated membrane reject

250 Combined membrane permeate and hydrogen stream

255 Filtration system

260 Microfiltration or ultrafiltration system

265 Membrane permeate

270 Static mixer

275 Combined membrane permeate and hydrogen stream

280 Stream of backwash water

285 Backwash water supply

290 Backwash overboard discharge

295 Stream of compressed air

300 Air scour supply

### DETAILED DESCRIPTION OF THE PREFERRED EMBODIMENTS

A system and process made according to this invention removes contaminants, such as dissolved inorganic salts and organic constituents, from a raw seawater feed before it enters a catalytic bed-based deoxygenation unit in order to reduce fouling of the deoxygenation unit. The contaminants are sent to disposal. The system may be comprised of nanofiltration, microfiltration, ultrafiltration, or reverse osmosis membrane systems. Each membrane system may have one or more stages.

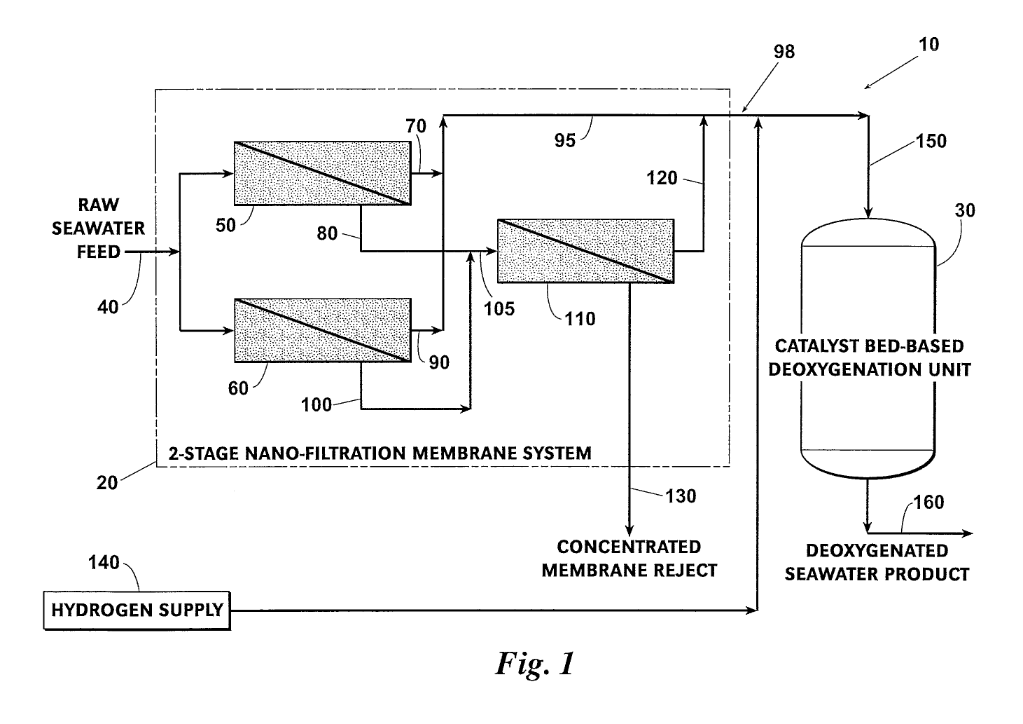

Referring first to FIG. 1, a preferred embodiment of a filtration system 10 includes a two-stage nanofiltration membrane system 20. Raw seawater feed 40 containing dissolved inorganic salts and organic constituents is directed to one of two first-stage nanofiltration membrane units 50, 60. Although two membrane units are shown in FIG. 1, the number of first-stage membrane units may vary with the quantity and quality of raw seawater to be processed, the amount of available space, and other factors. Each first-stage nanofiltration membrane unit 50, 60 contains a plurality of selectively permeable membranes that contact the raw seawater feed. A portion of the raw seawater feed passes through the membranes, forming a membrane permeate 70, 90 that is substantially free of the dissolved inorganic salts which are the major components of scale and the organic constituents responsible for organic fouling. The streams of membrane permeate 70, 90 from the first-stage nanofiltration membrane units 50, 60 are mixed to form a combined membrane permeate stream 95. The remaining raw seawater feed, which contains the dissolved inorganic salts and organic constituents that are too large to pass through the membranes, is concentrated into a stream of membrane reject 80, 100.

The streams of membrane reject 80, 100 from the first-stage nanofiltration membrane units 50, 60 are mixed to form a combined membrane reject stream 105 and routed to the second-stage nanofiltration membrane unit 110. FIG. 1 shows a single second-stage membrane unit. However, the number of membrane units in the second stage may vary with the quantity and quality of raw seawater to be processed, the amount of available space, and other factors. This nanofiltration membrane unit 110 also contains a plurality of selectively permeable membranes. These membranes contact the combined membrane reject stream 105 and allow a portion of it to pass through the membranes, forming a membrane permeate 120 that is substantially free of the dissolved inorganic salts which are the major components of scale and the organic constituents responsible for organic fouling. The remaining raw seawater feed, which contains the dissolved inorganic salts and organic constituents that are too large to pass through the membranes, forms a stream of concentrated membrane reject 130 which may be sent to disposal.

The stream of membrane permeate 120 from the second-stage nanofiltration membrane unit 110 may be mixed with the combined membrane permeate stream 95 from the first-stage nanofiltration membrane units 50, 60 to form a combined membrane permeate stream from the first and second stages 98. The combined membrane permeate stream from the first and second stages 98 is then mixed with hydrogen from a hydrogen supply 140 to form a combined membrane permeate and hydrogen stream 150, which is fed to the catalyst bed-based deoxygenation unit 30. The catalyst bed-based deoxygenation unit 30 removes dissolved oxygen from seawater by reacting it with hydrogen, creating a deoxygenated seawater product 160.

Although FIG. 1 depicts a two-stage system, the number of stages in a filtration membrane system may vary depending upon the characteristics of the raw seawater to be deoxygenated, the amount of available space, the rate at which the raw seawater must be treated, and other factors. In a single-stage system, the raw seawater feed may enter one filtration membrane unit or multiple filtration membrane units operating in parallel. The streams of membrane permeate from each membrane unit may then be combined, mixed with hydrogen, and fed to the catalyst bed-based deoxygenation unit. The streams of membrane reject from each membrane unit may be combined and sent to disposal. In systems with three or more stages, the membrane permeate from each stage may be routed to the deoxygenation unit, while the membrane reject may be routed to the filtration membrane unit or units at the next stage. At the final stage, the membrane reject may be sent for disposal.

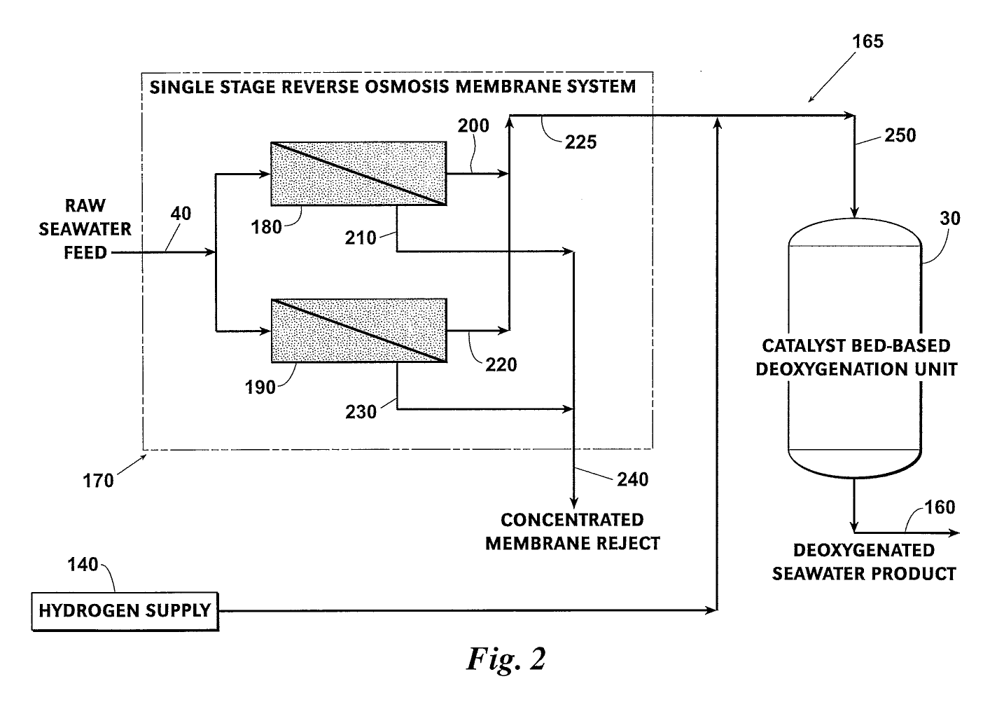

Referring now to FIG. 2, another preferred embodiment of a filtration system 165 includes a single-stage reverse osmosis membrane system 170. Raw seawater feed 40 containing dissolved inorganic salts and organic constituents is directed to one of two reverse osmosis membrane units 180, 190. Although two membrane units are shown in FIG. 2, the number of membrane units may vary with the quantity and quality of the raw seawater to be processed, the amount of available space, and other factors. Each reverse osmosis membrane unit 180, 190 contains a plurality of selectively permeable membranes that contact the raw seawater feed. A portion of the raw seawater feed passes through the membranes, forming a membrane permeate 200, 220 that is substantially free of the dissolved inorganic salts which are the major components of scale and the organic constituents responsible for organic fouling. The streams of membrane permeate 200, 220 from the reverse osmosis membrane units 180, 190 are mixed to form a combined membrane permeate stream 225. The combined membrane permeate stream 225 is then mixed with hydrogen from a hydrogen supply 140 to form a combined membrane permeate and hydrogen stream 250, which is fed to the catalyst bed-based deoxygenation unit 30. The catalyst bed-based deoxygenation unit 30 removes dissolved oxygen from seawater by reacting it with hydrogen, creating a deoxygenated seawater product 160.

The remaining seawater feed, which contains the dissolved inorganic salts and organic constituents that are too large to pass through the membranes, is concentrated into a stream of membrane reject 210, 230. The streams of membrane reject 210, 230 from the reverse osmosis membrane units 180, 190 are combined to form a stream of concentrated membrane reject 240 which may be sent to disposal.

Although FIG. 2 depicts a single-stage system, the number of stages in a filtration membrane system may vary depending upon the characteristics of the raw seawater to be deoxygenated, the amount of available space, the rate at which the raw seawater must be treated, and other factors. In a multiple-stage system, the raw seawater feed may enter one filtration membrane unit or multiple filtration membrane units operating in parallel. The streams of membrane permeate from each membrane unit may then be combined, mixed with hydrogen, and fed to the catalyst bed-based deoxygenation unit. The membrane reject from each unit may be combined and routed to the filtration membrane unit or units at the next stage. This process may be repeated until the final stage, which routes the membrane reject for disposal.

A system and process made according to this invention may also be designed to remove organic constituents from a raw seawater feed before it enters a catalytic bed-based deoxygenation unit in order to reduce fouling of the deoxygenation unit. The organic constituents are subsequently removed from the filtration system and sent for treatment or disposal. This filtration system may be comprised of a microfiltration system or an ultrafiltration system.

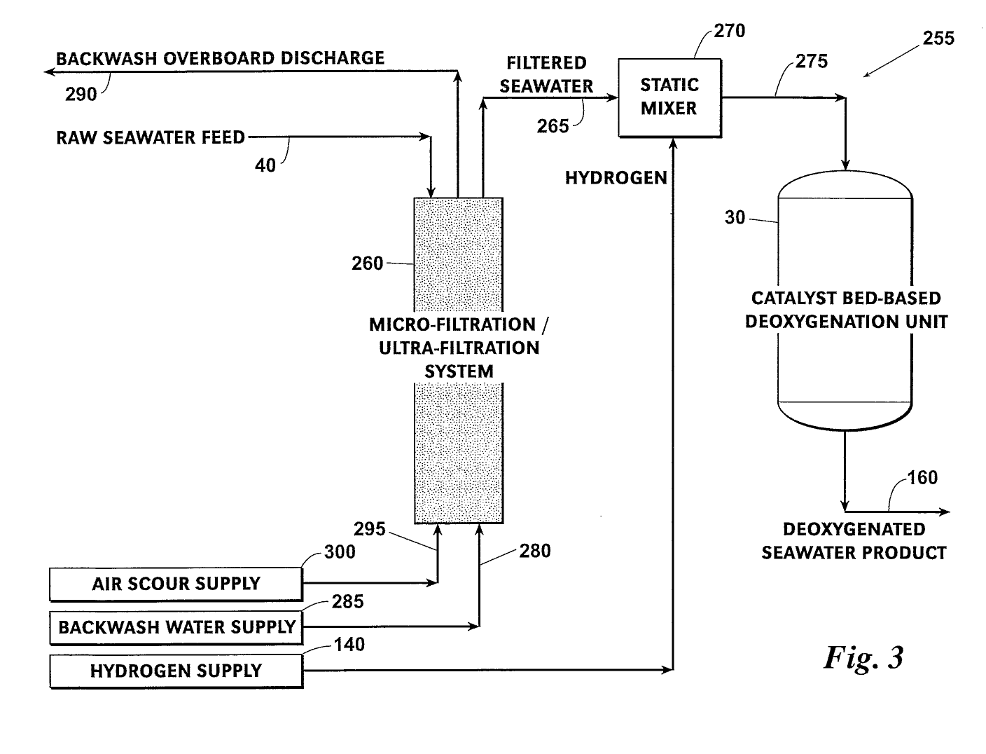

Referring to FIG. 3, a preferred embodiment of the system 255 includes a filtration system 260, which may be either a microfiltration or an ultrafiltration system. Microfiltration or “MF” may remove particulates that are equal to or greater than 0.1 micrometers in size, while ultrafiltration or “UF” may remove particulates that are equal to or greater than 0.01 micrometers in size. Raw seawater feed 40 containing organic constituents is directed to the filtration system 260. Although one filtration system is shown in FIG. 3, the number of filtration systems may vary with the quantity and quality of the raw seawater to be processed, the amount of available space, and other factors. The raw seawater feed 40 passes through the filtration system 260, forming a stream of membrane permeate 265 that is substantially free of the organic constituents which are the major components of organic fouling. A stream of hydrogen from a hydrogen supply 140 is then dispersed through the stream of membrane permeate 265 using a static mixer 270 or similar method. The combined membrane permeate and hydrogen stream 275 is then fed to a catalyst bed-based deoxygenation unit 30. The catalyst bed-based deoxygenation unit 30 removes dissolved oxygen from seawater by reacting it with hydrogen, creating a deoxygenated seawater product 160.

Although FIG. 3 depicts a one-stage system, the number of stages in a microfiltration or ultrafiltration system may vary depending upon the characteristics of the raw seawater to be deoxygenated, the amount of available space, the rate at which the raw seawater must be treated, and other factors. In a multiple-stage system, the raw seawater feed may enter one filtration system or multiple filtration systems operating in parallel. The filtered seawater from the first stage may then be directed to the filtration system or systems at the next stage if additional removal of organic constituents is required. This process may be repeated until the final stage, which routes the filtered seawater to the deoxygenation unit.

The organic constituents may be removed from the microfiltration or ultrafiltration system 260 by backwashing. In backwashing, a stream of backwash water 280 from a backwash water supply 285 is passed quickly through the microfiltration or ultrafiltration system 260 in a direction opposite to the normal direction of flow. The organic constituents trapped in the filtration system 260 are thus removed from the filter media and entrained in the backwash water 280. The backwash water 280 then exits the filtration system 260 through the backwash overboard discharge 290 and may be sent for further treatment or disposal. Air scouring, in which a stream of compressed air 295 from an air scour supply 300 is blown through the filtration system 260 in the same direction as the stream of backwash water 280, may be used before or intermittently with backwashing to aid in the removal of organic constituents.

While preferred embodiments of a system to reduce the inorganic and organic fouling of catalytic seawater deoxygenation units have been described in detail, a person of ordinary skill in the art understands that certain changes can be made in the arrangement of process steps and type of components used in the process without departing from the scope of the attached claims.

What is claimed is:

1. A system for reducing fouling in a catalytic bed-based deoxygenation unit, the system comprising:
a filtration system having a plurality of selectively permeable membranes arranged to contact a raw seawater feed and produce a membrane permeate; and
a catalyst bed-based deoxygenation unit that receives the membrane permeate,
wherein the membrane permeate is comprised of a portion of the raw seawater feed that has passed through the selectively permeable membranes, resulting in the removal of at least one contaminant.

2. A system according to claim 1 wherein the filtration system is chosen from the group consisting of a nanofiltration membrane system, a microfiltration membrane system, an ultrafiltration membrane system, and a reverse osmosis membrane system.

3. A system according to claim 1 wherein the contaminant is chosen from the group consisting of dissolved inorganic salts and organic constituents.

4. A system according to claim 1 wherein the filtration system has two stages.

5. A system according to claim 1 wherein the filtration system produces a concentrated membrane reject comprised of the contaminants that have been removed from the membrane permeate.

6. A system according to claim 1 wherein hydrogen is added to the membrane permeate before it enters the catalyst bed-based deoxygenation system.

7. A system according to claim 6 wherein a static mixer is used to disperse hydrogen through the membrane permeate before it enters the catalyst bed-based deoxygenation system.

8. A process for reducing fouling in a catalytic bed-based deoxygenation unit, the process comprising the steps of:
arranging a plurality of selectively permeable membranes within a filtration system to contact a raw seawater feed;
passing a portion of the seawater feed through the selectively permeable membranes to produce a membrane permeate from which at least one contaminant has been removed; and
routing the membrane permeate to a catalyst bed-based deoxygenation unit.

9. A process according to claim 8 wherein the filtration system is chosen from the group consisting of a nanofiltration membrane system, a microfiltration membrane system, an ultrafiltration membrane system, or a reverse osmosis membrane system.

10. A process according to claim 8 wherein the contaminant is chosen from the group consisting of dissolved inorganic salts and organic constituents.

11. A process according to claim 8 wherein the filtration system has two stages.

12. A process according to claim 8 wherein the filtration system produces a concentrated membrane reject comprised of the contaminants that have been removed from the membrane permeate.

13. A process according to claim 8 further comprising the step of adding hydrogen to the membrane permeate before it enters the catalyst bed-based deoxygenation system.

14. A process according to claim 13 wherein the hydrogen is dispersed through the membrane permeate by a static mixer.

15. A process according to claim 8, further comprising the step of backwashing the filtration system with water to remove organic constituents from the selectively permeable membranes.

16. A process according to claim 15, further comprising the step of blowing air through the filtration system before or during backwashing in a direction opposite that of the raw seawater feed to aid in removing organic constituents from the selectively permeable membranes.
